(19) United States
(12) Patent Application Publication
(10) Pub. No.: US 2019/0141673 A1
(43) Pub. Date: May 9, 2019

(54) MCS CONFIGURATION INDICATION METHOD, MCS CONFIGURATION ACQUISITION METHOD, BASE STATION, AND USER EQUIPMENT

(71) Applicant: SHARP KABUSHIKI KAISHA, Sakai City, Osaka (JP)

(72) Inventors: MENG ZHANG, Shanghai (CN); QI JIANG, Shanghai (CN); RENMAO LIU, Shanghai (CN)

(21) Appl. No.: 15/749,460

(22) PCT Filed: Aug. 1, 2016
(86) PCT No.: PCT/CN2016/092684

§ 371 Date: Jan. 31, 2018

(30) Foreign Application Priority Data
Aug. 5, 2015 (CN) 201510475198.3

(51) Int. Cl. H04W 72/00

(52) U.S. Cl. CPC H04W 72/005; H04W 88/08

(57) ABSTRACT

The present application discloses a Modulation and Coding Scheme (MCS) configuration indication method executed by a base station, and a corresponding base station. The method comprises steps of: including MCS configuration information of an Enhanced Physical Multicase Channel (E-PMCH) in a Radio Resource Control (RRC) signaling or a System Information Block (SIB13), wherein the E-PMCH is a PMCH that adopts Multi-user Superposition Transmission (MUST) technology; and sending the RRC signaling or SIB13 to a User Equipment (UE). The present application further discloses an MCS configuration acquisition method executed by a user equipment, and a corresponding user equipment.

### TECHNICAL FIELD

The present invention relates to the technical field of wireless communication. More particularly, the present invention relates to a Modulation and Coding Scheme (MCS) configuration indication method executed by a base station, an MCS configuration acquisition method executed by a User Equipment (UE), and a corresponding base station and UE.

### BACKGROUND

Modern wireless mobile communication systems present two significant characteristics. One is high-speed broadband, for example, the fourth generation wireless mobile communication system has a bandwidth of up to 100 MHz and a downlink speed of up to 1 Gbps. The other characteristic is mobile interconnection, which promotes emerging services, such as WAP, mobile phone video-on-demand, online navigation and the like. These two characteristics propose higher requirements for wireless mobile communication technology. Such requirements mainly include: ultrahigh-speed wireless transmission, inter-region interference suppression, mobile reliable signal transmission, distributed/centralized signal processing and the like. To satisfy the development requirements above, in a future, more enhanced Fourth Generation (4G) or Fifth Generation (5G) wireless mobile communication system, various corresponding key technologies will begin to be proposed and demonstrated, arousing the attention of researchers in the field. In October 2007, the International Telecommunication Union (ITU) approved the Worldwide Interoperability for Microwave Access (WiMAX) as the fourth third generation (3G) system standard. This event happened late in the 3G era and is actually a preview of the 4G standard battle. In fact, in response to the challenge of streams of wireless Internet protocol (IP) technologies represented by Wireless Local Area Network (WLAN) and WiMax, since 2005 the 3rd Generation Partnership Project 3GPP organization has embarked on a completely new system upgrade, i.e., standardization of Long Term Evolution (LTE). This is a quasi-fourth-generation system based on Orthogonal Frequency Division Multiplexing (OFDM) which was first released in early 2009 and started to be commercially available globally in 2010. Meanwhile, the 3GPP organization has launched the standardization of the Fourth Generation (4G) wireless mobile communication system in the first half of 2008. This system is called a Long Term Evolution Advanced (LTE-A) system. The key standardized document for the physical layer process of the system was completed in early 2011. In November 2011, the ITU organization officially announced in Chongqing, China that LTE-A systems and WiMax systems are two official standards for 4G systems. At present, the commercial process of LTE-A systems is being gradually expanded worldwide.

According to the challenges in the next decade, the following development needs for the enhanced fourth generation wireless mobile communication system are required:
a higher wireless broadband rate, with a focus on optimizing a localized cell hot area;
further improving the user experience, with a particular need to optimize communication services of cell boundary regions;
a need to continue studying new technology capable of improving the utilization efficiency of a spectrum, considering that an available spectrum cannot be expanded 1000 times;
high frequency spectra (5 GHz or higher) must be put into use to obtain larger communication bandwidths;
collaborative work of existing networks (2G/3G/4G, WLAN, WiMax, etc.) to share data traffic;
dedicated optimization for different businesses, applications, and services;
strengthening the system's ability to support large-scale machine communication;
flexible, intelligent and inexpensive network planning and network distribution;
designing a solution to save network power consumption and user equipment (UE) battery consumption.

In the conventional 3GPP LTE system, multiple pieces of user data can be transmitted over a single data stream, which is commonly referred to as Multi-user (MU) transmission technology. However, the traditional MU technology can obtain better performance only when the user's channels are as orthogonal as possible, which limits the flexibility of user scheduling to a certain extent. To this end, the 3GPP RAN #67 plenary discussed a new research topic, that is, the study of Multi-user Superposition Transmission (MUST), the main purpose of which is to study the function of transmitting multiple pieces of user information through single-stream data in an overlapping and superimposed manner by adjusting the power of multiple user-modulated signals. Compared with the traditional MU technology, the MUST technology does not require orthogonality between channels from the user to the base station. Therefore, with the use of the MUST technology, the base station can schedule users more flexibly. At present, the 3GPP may also use the MUST technology in a Multimedia Broadcast Multicast System (MBMS). On the basis of a Basic Enhanced Physical Multicase Channel (B-PMCH), the MUST technology is used to superpose an enhanced PMCH (E-PMCH) to achieve the goal of transmitting multiple PMCHs simultaneously.

However, for PMCH transmission using MUST technology, the traditional configuration signaling related to PMCH transmission may encounter the following problems:
MCS configuration information of the E-PMCH cannot be indicated and acquired, wherein the MCS configuration information specifically comprises MCS configuration information of a Multicast Control Channel (MCCH) corresponding to the E-PMCH, and MCS configuration information of a Multicast Traffic Channel (MTCH) corresponding to the E-PMCH.

Therefore, configuration signaling related to the PMCH (e.g., Radio Resource Control (RRC) signaling) in the MUST mode needs to be redesigned.

### SUMMARY

In view of the above problems, the present invention proposes a novel MCS configuration indication and acquisition scheme to support PMCH transmission using the MUST technology.

According to a first aspect of the present invention, a Modulation and Coding Scheme (MCS) configuration indication method executed by a base station is provided. The method comprises: including MCS configuration information of an Enhanced Physical layer Multicast Channel (E-PMCH) in Radio Resource Control (RRC) signaling or a System Information Block (SIB13), wherein the E-PMCH is superposed with a B-PMCH by adopting the MUST technology; and sending the RRC signaling or the SIB13 to a user equipment (UE).

According to a second aspect of the present invention, a base station is provided. The base station comprises: a signaling processing unit, used to include MCS configuration information of an E-PMCH in RRC signaling or a SIB13, wherein the E-PMCH is superposed with a B-PMCH by adopting the Multi-user Superposition Transmission MUST technology; and a transceiver, used to send the RRC signaling or the SIB13 to a UE.

According to a third aspect of the present invention, an MCS configuration acquisition method executed by a UE is provided. The method comprises: receiving RRC signaling or a SIB13 including MCS configuration information of an E-PMCH from a base station, wherein the E-PMCH is superposed with a B-PMCH by adopting the MUST technology; and extracting the MCS configuration information of the E-PMCH from the received RRC signaling or SIB13.

According to a fourth aspect of the present invention, a UE is provided. The UE comprises: a transceiver, used to receive RRC signaling or a SIB13 including MCS configuration information of an E-PMCH from a base station, wherein the E-PMCH is superposed with a B-PMCH by adopting the MUST technology; and a signaling processing unit, used to extract the MCS configuration information of the E-PMCH from the received RRC signaling or SIB13.

In the above first, second, third, and fourth aspects, when the B-PMCH and the E-PMCH correspond to the same Multicast Control Channel (MCCH), the MCS configuration information may comprise an MCS index value of the same MCCH corresponding to the B-PMCH and the E-PMCH indicated by the same information element (signallingMCS-MUST-r13).

In the above first, second, third, and fourth aspects, when the B-PMCH and the E-PMCH correspond to independent MCCHs, respectively, an MCS index value of an MCCH corresponding to the B-PMCH may be indicated by an information element (signallingMCS-r13); and the MCS configuration information may comprise an MCS index value of an MCCH corresponding to the E-PMCH indicated by the information element (signallingMCS-MUST-r13).

In the above first, second, third, and fourth aspects, when the B-PMCH and the E-PMCH correspond to the independent MCCHs, respectively, the MCS index value of the MCCH corresponding to the B-PMCH may be indicated by the information element (signallingMCS-r13); and the MCS configuration information may comprise an offset value of the MCS index value of the MCCH corresponding to the E-PMCH with respect to the MCS index value of the MCCH corresponding to the B-PMCH indicated by an information element (signallingMCS-Offset-r13).

In the above first, second, third, and fourth aspects, when the B-PMCH and the E-PMCH correspond to the independent MCCHs, respectively, the MCS configuration information may comprise a combination of the MCS index value of the MCCH corresponding to the B-PMCH and the MCS index value of the MCCH corresponding to the E-PMCH indicated by the same information element (signallingMCS-Indicator-r13).

In the above first, second, third, and fourth aspects, when the B-PMCH and the E-PMCH correspond to independent Multicast Traffic Channels (MTCHs), respectively, an MCS index value of an MTCH corresponding to the B-PMCH may be indicated by an information element (dataMCS-r13); and the MCS configuration information may comprise an MCS index value of an MTCH corresponding to the E-PMCH indicated by an information element (dataMCS-EPMCH-r13).

In the above first, second, third, and fourth aspects, when the B-PMCH and the E-PMCH correspond to the independent MTCHs, respectively, the MCS index value of the MTCH corresponding to the B-PMCH may be indicated by the information element (dataMCS-r13); and the MCS configuration information may comprise an offset value of the MCS index value of the MTCH corresponding to the E-PMCH with respect to the MCS index value of the MTCH corresponding to the B-PMCH indicated by an information element (dataMCS-Offset-r13).

In the above first, second, third, and fourth aspects, when the B-PMCH and the E-PMCH correspond to the independent MTCHs, respectively, the MCS configuration information may comprise a combination of the MCS index value of the MTCH corresponding to the B-PMCH and the MCS index value of the MTCH corresponding to the E-PMCH indicated by the same information element (dataMCS-r13).

### DESCRIPTION OF THE DRAWINGS

The above and other features of the present invention will be more apparent from the following detailed description taken in conjunction with the drawings, in which:

FIG. 1 is a flowchart illustrating an MCS configuration indication method executed by a base station according to an embodiment of the present invention;

FIG. 2 is a flowchart illustrating an MCS configuration acquisition method executed by a UE according to an embodiment of the present invention;

FIG. 3 is a sequence diagram illustrating respective processing of and signaling interaction between a base station and a UE according to an embodiment of the present invention;

FIG. 4 is a structural block diagram illustrating a base station according to an embodiment of the present invention; and

FIG. 5 is a structural block diagram illustrating a UE according to an embodiment of the present invention.

### DESCRIPTION OF THE EMBODIMENTS

The proposed MCS configuration indication scheme and MCS configuration acquisition scheme that support PMCH transmission using the MUST technology will be described below with reference to the accompanying drawings and detailed embodiments.

It is to be noted that the present invention shall not be limited to the specific embodiments described below. In addition, detailed descriptions of well-known technologies that are not directly related to the present invention are omitted for the sake of brevity, in order to avoid obscuring the understanding of the present invention.

Multiple embodiments according to the present invention are specifically described in example application environments of an LTE mobile communication system and its subsequent evolved versions. However, it is to be noted that the present invention is not limited to the following embodiments, but may be applied to more other wireless communication systems, such as a future 5G cellular communication system.

FIG. 1 shows a flowchart illustrating an MCS configuration indication method 100 executed by a base station according to an embodiment of the present invention. As shown in the figure, the method comprises the following steps.

Step s110, MCS configuration information of an E-PMCH is included in RRC signaling or a System Information Block (SIB13), wherein the E-PMCH is superposed with a B-PMCH by adopting the MUST technology.

As an embodiment, when the B-PMCH and the E-PMCH correspond to the same MCCH (that is, enhanced MCCH, the MCS of the E-PMCH may be transmitted by the following RRC signaling:

| | |
|---|---|
| -- ASNISTART | |
| MBSFN-AreaInfoList-r13 : := | SEQUENCE (SIZE(1 . .maxMBSFN-Area)) OF |
| MBSFN-AreaInfo-r13 | |
| MBSFN-AreaInfo-r13 : := | SEQUENCE { |

| | |
|---|---|
| mbsfn-AreaId-r13 | MBSFN-AreaId-r13, |
| non-MBSFNregionLength | ENUMERATED {s1, s2}, |
| notificationIndicator-r13 | INTEGER (0 . . 7), |
| mcch-Config-r13 | SEQUENCE { |

| | |
|---|---|
| mcch-RepeationPeriod-r13 | ENUMERATED {rf32, rf64, rf128, |
| rf256}, | |
| mcch-Offset-r13 | INTEGER (0 . . 10), |
| mcch-ModificationPeriod-r13 | ENUMERATED‘{rf512, rf1024}, |
| sf-AllocInfo-r13 | BIT STRING‘(SIZE(6)), |
| signalfingMCS-MUST-r13 | ENUMERATED‘{n2, n7, n13, n19} |
| } | |
| - - - | |
| } | |
| -- ASNISTOP | |

wherein an MCS of the MCCH corresponding to the B-PMCH and the E-PMCH is indicated by signallingMCS-MUST-r13; n2 represents a situation where an MCS index value (a value of I_{MCS}) in TS 36.213[table 7.1.7.1-1] is 2; n7, n13, and n19 are explained similarly.

As another embodiment, when the B-PMCH and the E-PMCH correspond to respective independent MCCHs, the MCS of the E-PMCH may be transmitted by the following RRC signaling:

| | |
|---|---|
| -- ASNISTART | |
| MBSFN-AreaInfoList-r13 : := | SEQUENCE (SIZE(1 . .maxMBSFN-Area)) OF |
| MBSFN-AreaInfo-r13 | |
| MBSFN-AreaInfo-r13 : := | SEQUENCE { |

| | |
|---|---|
| mbsfn-AreaId-r13 | MBSFN-AreaId-r13, |
| non-MBSFNregionLength | ENUMERATED {s1, s2}, |
| notificationIndicator-r13 | INTEGER (0 . . 7), |
| mcch-Config-r13 | SEQUENCE { |

| | |
|---|---|
| mcch-RepetitionPeriod-r13 | ENUMERATED {rf32, rf64, rf128, |
| rf256}, | |
| mcch-Offset-r13 | INTEGER (0 . . 10), |
| mcch-ModificationPeriod-r13 | ENUMERATED {rf512, rf1024}, |
| sf-AllocInfo-r13 | BIT STRING (SIZE(6)), |
| signallingMCS-r13 | ENUMERATED {n2, n7, n13, n19} |
| signallingMCS-MUST-r13 | ENUMERATED {n2, n7, n13, n19} |
| }, | |
| - - - | |
| } | |
| -- ASNISTOP | |

wherein signallingMCS-r13 is used to indicate an MCS of an MCCH corresponding to the B-PMCH; n2 represents a situation where the value of I_{MCS} in TS 36.213[table 7.1.7.1-1] is 2; and n7, n13, and n19 are explained similarly.

Herein, signallingMCS-MUST-r13 is used to indicate an MCS of an MCCH corresponding to the E-PMCH; n2 represents a situation where the value of I_{MCS} in TS 36.213[table 7.1.7.1-1] is 2; and n7, n13, and n19 are explained similarly.

As another embodiment, when the B-PMCH and the E-PMCH correspond to the respective independent MCCHs, the MCS of the E-PMCH may be transmitted by the following RRC signaling:

| | |
|---|---|
| -- ASNISTART | |
| MBSFN-AreaInfoList-r13 : := | SEQUENCE (SIZE(1 . .maxMBSFN-Area)) OF MBSFN- |
| AreaInfo-r13 | |
| MBSFN-AreaInfo-r13 : := | SEQUENCE { |

| | |
|---|---|
| mbsfn-AreaId-r13 | MBSFN-AreaId-r13, |
| non-MBSFNregionLength | ENUMERATED {s1, s2}, |
| notificationIndicator-r13 | INTEGER (0 . . 7), |
| mcch-Config-r13 | SEQUENCE { |

| | |
|---|---|
| mcch-RepetitionPeriod-r13 | ENUMERATED {rf32, rf64, rf128, |
| rf256}, | |
| mcch-Offset-r13 | INTEGER (0 . . 10), |
| mcch-ModificationPeriod-r13 | ENUMERATED {rf512, rf1024}, |
| sf-AllocInfo-r13 | BIT STRING (SIZE(6)), |
| signallingMCS-r13 | ENUMERATED {n2, n7, n13, n19} |
| signallingMCS-Offset-r13 | INTEGER (0 . . 32), |
| - - - | |
| } | |
| -- ASNISTOP | |

wherein signallingMCS-r13 is used to indicate the MCS of the MCCH corresponding to the B-PMCH; n2 represents a situation where the value of I_{MCS} in TS 36.213[table 7.1.7.1-1] is 2; and n7, n13, and n19 are explained similarly.

Herein, signallingMCS-Offset-r13 and signallingMCS-r13 are used together to indicate the MCS of the MCCH corresponding to the E-PMCH.

For example, when signallingMCS-r13 is n2 and signallingMCS-Offset-r13 is 5, it represents a situation where the value of I_{MCS} in TS 36.213[table 7.1.7.1-1] is 7(2+5).

As another embodiment, when the B-PMCH and the E-PMCH correspond to the respective independent MCCHs, the MCS of the E-PMCH may be transmitted by the following RRC signaling:

| | |
|---|---|
| -- ASNISTART | |
| MBSFN-AreaInfoList-r13 : := | SEQUENCE (SIZE(1 . .maxMBSFN-Area)) OF MBSFN- |
| AreaInfo-r13 | |
| MBSFN-AreaInfo-r13 : := | SEQUENCE { |

| | |
|---|---|
| mbsfn-AreaId-r13 | MBSFN-AreaId-r13, |
| non-MBSFNregionLength | ENUMERATED {s1, s2}, |
| notificationIndicator-r13 | INTEGER (0 . . 7), |
| mcch-Config-r13 | SEQUENCE { |

| | |
|---|---|
| mcch-RepetitionPeriod-r13 | ENUMERATED {rf32, rf64, rf128, |
| rf256}, | |
| mcch-Offset-r13 | INTEGER (0 . . 10), |
| mcch-ModificationPeriod-r13 | ENUMERATED {rf512, rf1024}, |
| sf-AllocInfo-r13 | BIT STRING (SIZE(6)), |
| signallingMCS-Indicator-r13 | BIT STRING (SIZE(6)) - - - |
| } | |
| -- ASNISTOP | |

wherein, signallingMCS-r13 is used to indicate a combination of the MCSs of the MCCH corresponding to the B-PMCH and the MCCH corresponding to the E-PMCH. Table 1 lists an indication method for an MCS combination, wherein second and third columns of numerical values correspond to the value of I_{MCS} in TS 36.213[table 7.1.7.1-1].

TABLE 1
Index values of MCSs of MCCH of B-PMCH
and MCCH of E-PMCH

| | MCS index value of | MCS index value of |
|---|---|---|
| signallingMCS-Indicator-r13 | MCCH of B-PMCH | MCCH of E-PMCH |
| 0000 | 2 | 2 |
| 0001 | 2 | 7 |
| 0010 | 2 | 13 |
| 0011 | 2 | 19 |
| 0100 | 7 | 2 |
| 0101 | 7 | 7 |
| 0110 | 7 | 13 |
| 0111 | 7 | 19 |
| 1000 | 13 | 2 |
| 1001 | 13 | 7 |
| 1010 | 13 | 13 |
| 1011 | 13 | 19 |
| 1100 | 19 | 2 |
| 1101 | 19 | 7 |
| 1110 | 19 | 13 |
| 1111 | 19 | 19 |

When the value of signallingMCS-Indicator-r13 is 0000, it represents that the MCS of the MCCH corresponding to the B-PMCH is 2 and the MCS of the MCCH corresponding to the E-PMCH is 2.

When the value of signallingMCS-Indicator-r13 is 0001, it represents that the MCS of the MCCH corresponding to the B-PMCH is 2 and the MCS of the MCCH corresponding to the E-PMCH is 7.

When the value of signallingMCS-Indicator-r13 is 0010, it represents that the MCS of the MCCH corresponding to the B-PMCH is 2 and the MCS of the MCCH corresponding to the E-PMCH is 13.

When the value of signallingMCS-Indicator-r13 is 0011, it represents that the MCS of the MCCH corresponding to the B-PMCH is 2 and the MCS of the MCCH corresponding to the E-PMCH is 19.

When the value of signallingMCS-Indicator-r13 is 0100, it represents that the MCS of the MCCH corresponding to the B-PMCH is 7 and the MCS of the MCCH corresponding to the E-PMCH is 2.

When the value of signallingMCS-Indicator-r13 is 0101, it represents that the MCS of the MCCH corresponding to the B-PMCH is 7 and the MCS of the MCCH corresponding to the E-PMCH is 7.

When the value of signallingMCS-Indicator-r13 is 0110, it represents that the MCS of the MCCH corresponding to the B-PMCH is 7 and the MCS of the MCCH corresponding to the E-PMCH is 13.

When the value of signallingMCS-Indicator-r13 is 0111, it represents that the MCS of the MCCH corresponding to the B-PMCH is 7 and the MCS of the MCCH corresponding to the E-PMCH is 19.

When the value of signallingMCS-Indicator-r13 is 1000, it represents that the MCS of the MCCH corresponding to the B-PMCH is 13 and the MCS of the MCCH corresponding to the E-PMCH is 2.

When the value of signallingMCS-Indicator-r13 is 1001, it represents that the MCS of the MCCH corresponding to the B-PMCH is 13 and the MCS of the MCCH corresponding to the E-PMCH is 7.

When the value of signallingMCS-Indicator-r13 is 1010, it represents that the MCS of the MCCH corresponding to the B-PMCH is 13 and the MCS of the MCCH corresponding to the E-PMCH is 13.

When the value of signallingMCS-Indicator-r13 is 1011, it represents that the MCS of the MCCH corresponding to the B-PMCH is 13 and the MCS of the MCCH corresponding to the E-PMCH is 19.

When the value of signallingMCS-Indicator-r13 is 1100, it represents that the MCS of the MCCH corresponding to the B-PMCH is 19 and the MCS of the MCCH corresponding to the E-PMCH is 2.

When the value of signallingMCS-Indicator-r13 is 1101, it represents that the MCS of the MCCH corresponding to the B-PMCH is 19 and the MCS of the MCCH corresponding to the E-PMCH is 7.

When the value of signallingMCS-Indicator-r13 is 1110, it represents that the MCS of the MCCH corresponding to the B-PMCH is 19 and the MCS of the MCCH corresponding to the E-PMCH is 13.

When the value of signallingMCS-Indicator-r13 is 1111, it represents that the MCS of the MCCH corresponding to the B-PMCH is 19 and the MCS of the MCCH corresponding to the E-PMCH is 19.

As another embodiment, when the B-PMCH and the E-PMCH correspond to independent MTCHs, the MCS of the E-PMCH may be transmitted by the following RRC signaling:

| | |
|---|---|
| PMCH-Config-r13 : := | SEQUENCE { |
| sf-AllocEnd-r13 | INTEGER (0 . . 1535), |
| dataMCS-r13 | CHOICE { |
| nomal-r13 | INTEGER (0 . . 28), |
| higerOrder-r13 | INTEGER (0 . . 27) |
| }, | |
| dataMCS-EPMCH-r13 | CHOICE { |
| nomal-r13 | INTEGER (0 . . 28), |
| highOrder-r13 | INTEGER (0 . . 27), |
| }, | |
| mch-SchedulingPeriod-r13 | ENUMERATED { |
| | rf4, rf8, rf16, rf32, rf64, rf128, rf256, |
| rf512, rf1024}, | |
| - - - | |
| } | |

wherein dataMCS-EPMCH-r13 indicates an MCS of an MTCH corresponding to the E-PMCH. A value of normal corresponds to table 7.1.7.1-1 in TS 36.213. A value of higherOrder corresponds to table 7.1.7.1-A in TS 36.213.

As another embodiment, when the B-PMCH and the E-PMCH correspond to the independent MTCHs, the MCS of the E-PMCH may be transmitted by the following RRC signaling:

| | |
|---|---|
| PMCH-Config-r13 : := | SEQUENCE { |
| sf-AllocEnd-r13 | INTEGER (0 . . 1535), |
| dataMCS-r13 | CHOICE { |
| nomal-r13 | INTEGER (0 . . 28), |
| higerOrder-r13 | INTEGER (0 . . 27) |
| }, | |
| dataMCS-Offset-r13 | CHOICE { |
| offset-nomal-r13 | INTEGER (0 . . 28), |
| offset-highOrder-r13 | INTEGER (0 . . 27), |
| }, | |
| mch-SchedulingPeriod-r13 | ENUMERATED { |
| | rf4, rf8, rf16, rf32, rf64, rf128, rf256, |
| rf512, rf1024}, | |
| - - - | |
| } | |

wherein dataMCS-Offset-r13 and dataMCS-r13 together indicate the MCS of the MTCH corresponding to the E-PMCH. A value of the sum of normal-r13 and offset-normal-r13 corresponds to table 7.1.7.1-1 in TS36.213. A value of the sum of higerOrder-r13 and offset-highOrder-r13 corresponds to table 7.1.7.1-IA in TS 36.213.

As another embodiment, when the B-PMCH and the E-PMCH correspond to the independent MTCHs, the MCS of the E-PMCH may be transmitted by the following RRC signaling:

| | |
|---|---|
| PMCH-Config-r13 : := | SEQUENCE { |
| sf-AllocEnd-r13 | INTEGER (0 . . 1535), |
| dataMCS-r13 | BIT STRING (M) |
| mch-SchedulingPeriod-r13 | ENUMERATED { |
| | rf4, rf8, rf16, rf32, rf64, |
| | rf128, r1256, |
| rf512, rf1024}, | |
| - - - | |
| } | |

wherein dataMCS-r13 is used to indicate a combination of the MCSs of the MTCH corresponding to the B-PMCH and the MTCH corresponding to the E-PMCH. Table 2 lists an indication method for an MCS combination, wherein second and third columns of numerical values correspond to the value of I_{MCS} in TS 36.213[table 7.1.7.1-1].

| | Index value | Index value |
|---|---|---|
| | of MCS of | of MCS of |
| signallingMCS-Indicator-r13 | MTCH of B-PMCH | MTCH of E-PMCH |
| 00 | 2 | 2 |
| 01 | 2 | 7 |
| 10 | 2 | 13 |
| 11 | 2 | 19 |

When the value of signallingMCS-Indicator-r13 is 00, it represents that the MCS of the MTCH corresponding to the B-PMCH is 2 and the MCS of the MTCH corresponding to the E-PMCH is 2.

When the value of signallingMCS-Indicator-r13 is 01, it represents that the MCS of the MTCH corresponding to the B-PMCH is 2 and the MCS of the MTCH corresponding to the E-PMCH is 7.

When the value of signallingMCS-Indicator-r13 is 10, it represents that the MCS of the MTCH corresponding to the B-PMCH is 2 and the MCS of the MTCH corresponding to the E-PMCH is 13.

When the value of signallingMCS-Indicator-r13 is 11, it represents that the MCS of the MTCH corresponding to the B-PMCH is 2 and the MCS of the MTCH corresponding to the E-PMCH is 19.

In step s120, the RRC signaling or the SIB13 produced in step s110 is sent to the user equipment (UE).

By executing the above MCS configuration information indication method 100, the base station can indicate the MCS configuration information of the E-PMCH to the UE, so as to effectively support PMCH transmission that uses the MUST technology.

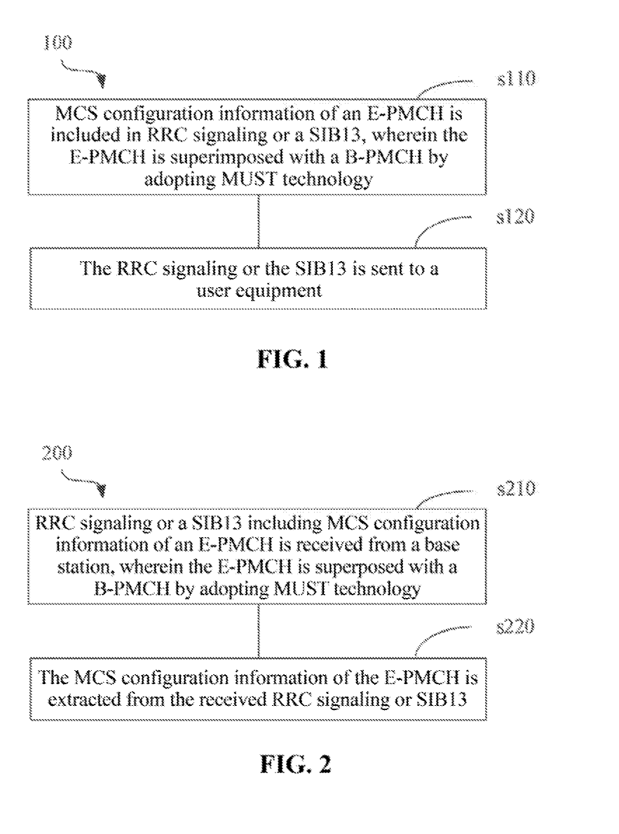

The present invention further proposes an MCS configuration acquisition method 200 executed by a UE, which corresponds to the above MCS configuration indication method 100 executed by the base station. As shown in FIG. 2, the method 200 comprises the following steps.

Step s210, RRC signaling or a SIB13 including MCS configuration information of an E-PMCH is received from a base station, wherein the E-PMCH is superposed with a B-PMCH by adopting the MUST technology.

Step s220, the MCS configuration information of the E-PMCH is extracted from the received RRC signaling or SIB13.

As those skilled in the art will appreciate, the RRC signaling or the SIB13 received by the UE from the base station in the method 200 is exactly the RRC signaling or the SIB13 sent by the base station to the U E in the method 100.

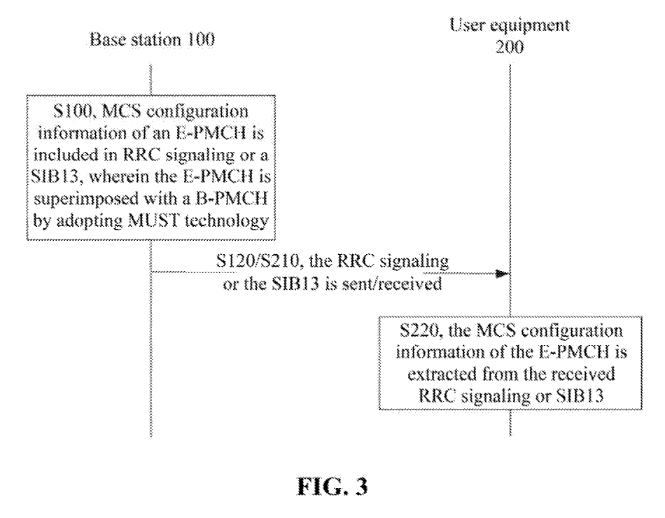

For ease of understanding, FIG. 3 further illustrates a sequence diagram showing respective processing of and signaling interaction between the base station and the UE according to an embodiment of the present invention. As shown in the figure, firstly, step s110 in the method 100 is executed at a base station side; and subframe configuration information of the E-PMCH is included in the RRC signaling or the system information block SIB13. Then step s120 in the method 100 is executed to send the RRC signaling or the SIB13 produced in step s110 to the UE. Correspondingly, step s210 in the method 200 is executed at a UE side to receive the RRC signaling or the SIB13 including the subframe configuration information of the E-PMCH from the base station. Then, step s220 is executed to extract the subframe configuration information of the E-PMCH from the received RRC signaling or SIB13.

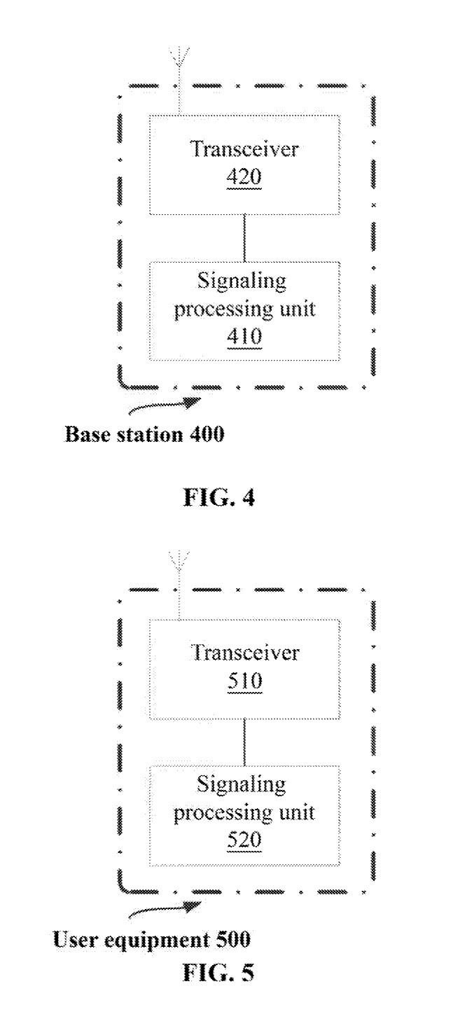

FIGS. 4 and 5 respectively illustrate structural block diagrams of a base station 400 and a user equipment 500 corresponding to the MCS configuration indication method executed by the base station and the MCS configuration acquisition method executed by the UE described with reference to FIGS. 1 and 2.

As shown in FIG. 4, the base station 400 comprises a signaling processing unit 410 and a transceiver 420. The signaling processing unit 410 is used to include the MCS configuration information of the E-PMCH in the RRC signaling or the SIB13. The transceiver 420 is used to send the RRC signaling or the SIB13 to the user equipment.

As shown in FIG. 5, the user equipment 500 includes a transceiver 510 and a signaling processing unit 520. The transceiver 510 is used to receive the RRC signaling or the SIB13 including the MCS configuration information of the E-PMCH from the base station. The signaling processing unit 520 is used to extract the MCS configuration information of the E-PMCH from the received RRC signaling or SIB13.

It is to be understood that the above-described embodiments of the present invention may be implemented by software or by hardware or by a combination of both software and hardware. For example, various components inside the base station and the UE in the above-described embodiments may be implemented by various devices, which include, but are not limited to: analog circuit devices, digital circuit devices, digital signal processing (DSP) circuits, programmable processors, application specific integrated circuits (ASICs), field programmable gate arrays (FPGAs), programmable logic devices (CPLDs), and the like.

In the present application, “a base station” refers to a mobile communication data and control switching center provided with a larger transmitting power and a wider coverage area and including functions such as resource allocation and scheduling, and data receiving and sending. “A user equipment” refers to a user mobile terminal, for example, a terminal device that can wirelessly communicate with a base station or a micro base station, such as a mobile phone or a notebook.

In addition, the embodiments of the present invention disclosed herein may be implemented on a computer program product. More specifically, the computer program product is a product having a computer-readable medium having computer program logic encoded thereon that, when executed on a computing device, provides related operations to implement the above-described technical solutions of the present invention. When executed on at least one processor of a computing system, the computer program logic causes the processor to perform the operations (methods) described in the embodiments of the invention. Such an arrangement of the present invention is typically provided as software, codes and/or other data structures disposed on or encoded on a computer-readable medium such as an optical medium (eg, a CD-ROM), a floppy disk or a hard disk, or other media such as firmware or microcode on one or more ROM or RAM or PROM chips, or downloadable software images and shared databases in one or more modules etc. Software or firmware or such a configuration may be installed on a computing device to cause one or more processors in the computing device to implement the technical solutions described in the embodiments of the present invention.

While the present invention has been illustrated in connection with the preferred embodiments of the present invention, it will be understood by those skilled in the art that various modifications, substitutions, and alterations may be made to the present invention without departing from the spirit and scope of the invention. Therefore, the present invention should not be limited by the above-described embodiments, but should be defined by the appended claims and their equivalents.

1. A Modulation and Coding Scheme (MCS) configuration indication method executed by a base station, comprising:
including MCS configuration information of an Enhanced Physical Multicast Channel (E-PMCH) in a Radio Resource Control (RRC) signaling or a System Information Block (SIB13), wherein the E-PMCH is superposed with a Basic Enhanced Physical Multicast Channel (B-PMCH) by adopting Multi-User Superposition Transmission (MUST) technology; and
sending the RRC signaling or the SIB13 to a User Equipment (UE).

2. The method according to claim 1, wherein when the B-PMCH and the E-PMCH correspond to the same MCCH, the MCS configuration information comprises an MCS index value of the same MCCH corresponding to the B-PMCH and the E-PMCH indicated by the same information element (signallingMCS-MUST-r13).

3. The method according to claim 1, wherein when the B-PMCH and the E-PMCH correspond to independent MCCHs, respectively, an MCS index value of an MCCH corresponding to the B-PMCH is indicated by an information element (signallingMCS-r13); and the MCS configuration information comprises an MCS index value of an MCCH corresponding to the E-PMCH indicated by the information element (signallingMCS-MUST-r13).

4. The method according to claim 1, wherein when the B-PMCH and the E-PMCH correspond to the independent MCCHs, respectively, the MCS index value of the MCCH corresponding to the B-PMCH is indicated by the information element (signallingMCS-r13); and the MCS configuration information comprises an offset value of the MCS index value of the MCCH corresponding to the E-PMCH with respect to the MCS index value of the MCCH corresponding to the B-PMCH indicated by an information element (signallingMCS-Offset-r13).

5. The method according to claim 1, wherein when the B-PMCH and the E-PMCH correspond to the independent MCCHs, respectively, the MCS configuration information comprises a combination of the MCS index value of the MCCH corresponding to the B-PMCH and the MCS index value of the MCCH corresponding to the E-PMCH indicated by the same information element (signallingMCS-Indicator-r13).

6. The method according to claim 1, wherein when the B-PMCH and the E-PMCH correspond to independent Multicast Traffic Channels (MTCHs), respectively, an MCS index value of an MTCH corresponding to the B-PMCH is indicated by an information element (dataMCS-r13); and the MCS configuration information comprises an MCS index value of an MTCH corresponding to the E-PMCH indicated by an information element (dataMCS-EPMCH-r13).

7. The method according to claim 1, wherein when the B-PMCH and the E-PMCH correspond to the independent MTCHs, respectively, the MCS index value of the MTCH corresponding to the B-PMCH is indicated by the information element (dataMCS-r13); and the MCS configuration information comprises an offset value of the MCS index value of the MTCH corresponding to the E-PMCH with respect to the MCS index value of the MTCH corresponding to the B-PMCH indicated by an information element (dataMCS-Offset-r13).

8. The method according to claim 1, wherein when the B-PMCH and the E-PMCH correspond to the independent MTCHs, respectively, the MCS configuration information comprises a combination of the MCS index value of the MTCH corresponding to the B-PMCH and the MCS index value of the MTCH corresponding to the E-PMCH indicated by the same information element (dataMCS-r13).

9. A base station, comprising:
a signaling processing unit, used to include MCS configuration information of an E-PMCH in RRC signaling or a SIB13, wherein the E-PMCH is superposed with a B-PMCH by adopting MUST technology;
a transceiver, used to send the RRC signaling or the SIB13 to a UE.

10. An MCS configuration acquisition method executed by a UE, comprising:
receiving RRC signaling or a SIB13 including MCS configuration information of an E-PMCH from a base station, wherein the E-PMCH is superposed with a B-PMCH by adopting MUST technology; and
extracting the MCS configuration information of the E-PMCH from the received RRC signaling or SIB13.

11. A user equipment, comprising:
a transceiver, used to receive RRC signaling or a SIB13 including MCS configuration information of an E-PMCH from a base station, wherein the E-PMCH is superposed with a B-PMCH by adopting MUST technology; and
a signaling processing unit, used to extract the MCS configuration information of the E-PMCH from the received RRC signaling or SIB13.
